(19) United States
(12) Patent Application Publication
(10) Pub. No.: US 2026/0112859 A1
(43) Pub. Date: Apr. 23, 2026

(54) METHOD AND SYSTEM FOR COMPENSATING THERMALLY INDUCED BEAM DEGRADATION IN REFLECTIVE CHIRPED VOLUME BRAGG GRATING

(71) Applicant: IPG PHOTONICS CORPORATION, Marlborough, MA (US)

(72) Inventors: Alex Podvazny, Ashland, MA (US); Artem Demkin, Burlington, MA (US)

(73) Assignee: IPG PHOTONICS CORPORATION, Marlborough, MA (US)

(21) Appl. No.: 18/921,492

(22) Filed: Oct. 21, 2024

(51) Int. Cl. H01S 3/08; H01S 3/00; H01S 3/04

(52) U.S. Cl. CPC H01S 3/08009; H01S 3/0057; H01S 3/0405; H01S 3/08072

(57) ABSTRACT

A high-power laser system includes at least one high-power laser source outputting a substantially single mode (SM) beam. The SM beam is coupled into a reflective volume Bragg grating (RVBG) made of material which absorbs the SM beam to induce a first thermal lens (TL). Upon reflecting, the beam exits the RVBG through the first TL and is coupled into an optical compensator made from material different from that of the first TL and inducing a second TL. The second TL is configured to have a power opposite to that of the first TL matching to that of the first TL to least partially compensate a heat induced thermal degradation of the reflected beam by the first TL.

### BACKGROUND OF THE DISCLOSURE

### Field of the Disclosure

The present disclosure relates to industrial laser systems. In particular, the disclosure relates to a method and system for minimizing detrimental effects of the thermal lensing in reflective volume Bragg gratins (RVBG).

### The Known Art

The current industrial landscape is dominated by a great variety of industrial lasers including, among others, solid state lasers, fiber lasers etc. For all the structural diversity of industrial lasers, most of them must meet the ever-increasing industrial demand for high output beam powers. Still another requirement for a large segment of industrial lasers is high beam quality. While single-mode (SM) lasers have better beam quality including a smaller focus beam spot diameter, lower divergence and higher power compared to multimode (MM) lasers, the high-quality beam requirement is generally applicable to both SM and MM lasers.

Many applications of SM ultrashort (sub-nanosecond) laser pulses in industry require high average power and high pulse energy. However, direct amplification of ultrashort pulses can induce detrimental nonlinear effects and/or laser-induced damage in amplifiers due to the extremely high peak power of the amplified pulses. A technique called chirped pulse amplification (CPA) was developed to mitigate these effects. An exemplary CPA system 50 of FIG. 1 generally includes, among other components, a tunable sub-nanosecond SM seed laser, a stretcher which increases the duration of short, typically femtosecond pulses up to a few nanoseconds, one or more pre-amplifying and booster stages. Finally, CPA system 50 necessarily has a compressor which restores the previously amplified stretched pulse to its initial duration using the inverse process of the initial stretching. The compressed pulses typically are incident on a scanner and focusing lens which irradiates the object to be laser-treated.

Pulse stretching and compression in CPA systems can be conveniently realized using dispersive elements such as diffraction volume and fiber Bragg gratins (VBG, FBG respectively.) In the context of ultra-short lasers, these dispersive elements, and more particularly chirped VBG (CVBG) and chirped FBG (CFBG) are used as pulse stretches and compressors and greatly enhance the system compactness, alignment, efficiency and robustness. The CVBGs can stretch pulses each to a few hundreds of picoseconds, while the compressor recompress it to femtosecond duration in only a few centimeters of glass.

The use of VBGs is not limited to CPA laser systems. FIG. 2 illustrates a high-power laser system 52 including a reflective VBG (RVBG) operable to combine collimated beams at respective different wavelengths [symbol] ₁- [symbol] n which are incident on RVBG at different angles. As shown, the RVBG is tuned to reflect incident beams at respective wavelengths [symbol] ₁, [symbol] n-1, whereas an incident beam at wavelength [symbol] n propagates through the RVBG undisturbed. The RVBG is configured to spectrally combine all incident collimated beams each of which converges individually and toward one another due to the generation of a thermal lens (TL), as explained below.

A CVBG is a volume holographic grating produced by recording the interference pattern of converging and diverging beams. This recording results in the creation of numerous planar layers of gradually varying thickness and thus period A along the beam propagation in the volume of the photosensitive optical material. The layers provide a diffraction of respective resonant frequency components if the Bragg condition, well known to one of ordinary skill in the laser arts, is satisfied. The CVBG can operate in reflecting or transmitting geometry. In the reflecting CVBG, which is part of the disclosed subject matter, different wavelengths/spectral components reflect from respective different planar layers.

The application of high intensity ultra-short pulses in CPA laser systems generates quick and significant in scale thermal distribution ΔT. As the SM (TEM00) laser beam has the intensity that gradually decreases from the beam axis to its edges, absorption of such a beam in the photosensitive material, such as glass, leads to the formation of a temperature gradient ΔT. When the intensity is high, as is the case with CPA laser systems, even a small absorption gives rise to a significant inhomogeneous temperature distribution. The latter is characterized by dn/dT≠0 and corresponds to a refractive index distribution, Δn which is referred to as the TL. The effect that Δn takes on light is called the “thermal lensing”, and the minimization or even complete elimination of its undesirable consequences, discussed herein below, is a primary focus of the inventive system and method disclosed in this application.

FIGS. 3A-3C illustrate the TL and its undesirable effects on light pulses compressed in a CVBG 10. Collimated stretched pulses 16 each are incident on a surface 22 of a CVBG 10. Upon coupling, multiple spectral components [symbol] ₁ . . . [symbol] ₙ of the incident beam are reflected from respective planar layers. As a result, a combined reflected beam 18 is compressed and exits CVBG 10 through same surface 22. At some point, any beam, even the collimated one, converges thus forming a waist and is characterized by the Rayleigh length—the distance from the beam waist and the beam region where the beam radius is increased by a factor of the square root of 2. For Gaussian beams, which are of a particular interest here, the Rayleigh length is Z_{R=πω}_{²}ₒ/ [symbol] where [symbol] is the wavelength and ωₒ is the Gaussian waist radius. The concept of the Rayleigh length plays an important role for the inventive method and system and will be revisited below.

FIG. 3B and FIG. 3C illustrate what occurs when high intensity pulses interact with the photosensitive material of CVBG 10 configured, as shown, as a RCVBG. For RCVBG compressor 10, the intensity is high at its entrance and low at the rear end, giving both a longitudinal and a transverse temperature variation ΔT which creates a heat zone 12 and triggers a TL 14. Many materials used for the CVBG production demonstrate the refractive index increase as the ΔT grows. These materials are known for generating a positive thermal lens, i.e., the lens that converges beams propagating through it in both incident and particularly reflective directions. The higher the thermal index distribution, the higher the power of TL 14, the shorter the focal length of TL 14. In other words, the beam waist of each reflective beam 18 shifts closer to RVBG 10 as the dn/dT increases which causes reflected beams 18 to converge progressively closer to RVBG 10 as the TL power increases.

The variable waist position represents one of the problems directly stemming from TL 14. For example, the material laser processing often requires that a distance between a laser head, in which the compressor is typically mounted, and the object to be processed remain constant. The variation of the TL power causes the deviation of the above-mentioned distance from the desired value. Such a deviation frequently leads to poor-quality products.

The formation of TL 14 affects not only the beam convergence, but above all the beam parameter M². The latter indicates deterioration of the output beam quality and thus presents another essential problem caused by the TL. Shown in FIG. 3C as an example, TL 14 is responsible for increasing M²=1 of SM incident beam 16 to M²=1.4 of compressed output beam 18.

In summary, the reflected beam progressively degrades as the TL power increases because of optical aberrations caused by TL 14 and difference in convergence for each spectral component. These undesirable optical effects detrimentally affect the final product quality.

A need, therefore, exists for an optical compensating system configured to mitigate and, preferably, eliminate the beam distortion induced by thermal lensing which is formed in reflective VBGs at high average power levels.

Still another need exists for a method of configuring and tuning the optical compensating system for minimizing the beam distortion induced by thermal lensing in reflective VBGs.

### SUMMARY OF THE DISCLOSURE

Conceptually, the current disclosure relates to a high-power laser system incorporating the inventive optical assembly which is configured to minimize thermally induced beam degradation in reflective CVBGs. The high-power laser system may have a standard CPA schematic with a high-power SM pulsed laser source of ultrashort pulses. Alternatively, the laser system may include a plurality of SM laser sources outputting respective beams at different angles. The beams are incident on a dispersive element made of glass which has multiple RVBGs (MRVBG) written in and reflecting respective beams which satisfy the Bragg condition. Therefore, the reflected beams are spectrally combined. In either of the disclosed high-power laser systems, the inventive optical assembly includes a compensator receiving the beams which are incident on and_reflected from the RCVBG/RVBG. As the name goes, the compensator partially or fully compensates the beam degradation which is induced by a TL formed in the RCVBG/RVBG.

One aspect of the disclosure relates to an optical system compensating the above-discussed detrimental effects of thermal lensing in RVBGs or RCVBGs at high average power levels. The optical system is configured with a compensator-an optical component made of the material with a dn/dT value (TL) which is inverse to that of the TL generated in the CVBG. In other words, the incident and reflected beams propagating in the CVBG induce the TL, and if the latter is characterized by a positive TL, the compensator is made of material inducing a negative TL, and vice versa. Thus, a thermal lens profile across the aperture in the compensator is inverted relative to that of the CVBG. The thermal lens power of the negative TL changes over the average power of the beam with same dynamics as the one in the CVBG. The deployment of the compensator with a TL with the dn/dT value inverse to that of the RCVBG minimizes optical aberrations, and as a result, improves the M² factor of the reflected beam at the output of the compensator. To further mitigate the beam degradation, the compensator is configured so that its TL has a lens power substantially matching that of the CVBG. This is accomplished by determining the compensator's length, average temperature and material. The determination may be made empirically or theoretically, as readily realized by one of ordinary skill in the laser optics. Generally, the greater the length and/or the temperature of the compensator, the higher the TL power, the smaller the focusing length.

As mentioned above, the negative TL power can be adjusted by controllably heating the compensator. Accordingly, the disclosed TL compensating optical system may optionally include a controllable heater, such as thermoelectric coolers, in thermal communication with the compensator. Depending on thermal resistance of the material of the compensator, the latter may be placed inside a housing.

The relative position between the RCVBG and compensator of the disclosed system is an important factor. As one of ordinary skill readily realizes, the RVBG and compensator must be spaced from one another at a distance which is one or two orders of magnitude smaller than_the focal length of the positive TL. For example, an RCVBG impinged by 100 W light (average power) forms a Tl with about a one (1) meter focal length. In this example, the best results were obtained with the compensator spaced from the CVBG at a few millimeters. Ultimately, structural and manufacturing limitations dictate an optimal distance between these components, but ideally, the compressor and compensators are positioned next to one another. The closer the CVBG and compensator to one another, the more effective minimization of the beam distortion and more stable position of the beam waist within the Rayleigh length of the reflected beam at the output of the compensator. One of the structural possibilities of this configuration is to have the opposing surfaces of respective CVBG and compensator in optical contact. Alternatively, an adhesive may be used without distorting optical communication between these components. A housing configured to keep the CVBG and compensator in mechanical contact is still another structural possibility.

The other aspect of the disclosure relates to a method of compensating thermally induced beam distortion in RVBG/RCVBG which includes selecting a compensator made from material which induces a TL with the dn/dT value opposite to that of the CVBG. The configuration of the inverted TL limits the M² factor of the reflected beam to max M²=1.4. If the CVBG is made of material inducing a positive TL, the compensator is characterized by a negative TL.

The method further includes determining the dimensions of the compensator sufficient to provide the TL generated in this component with a lens power which matches that of the RVBG/RCVGB. The compensator's length factors in effective minimization of the beam distortion and helps curtail a shift of the beam waist of the reflected beam within the Rayleigh length. Advantageously, the laser system incorporating the compensator is configured to operate within a broad output power range. Accordingly, the waist shift does not exceed 0.6-0.75 of the reference value, which corresponds to the beam's Rayleigh length at the specified optimal power, within the selected output power range.

In accordance with another feature of the disclosed method, the compensator may be tuned to adjust the M² factor by controllably heating the compensator.

According to still another feature, the disclosed method includes spacing the VBG/CVBG and compensator at the desired distance which is one or two orders of magnitude smaller than the focal length of TL. In one practical implementation, these two components of the inventive system can be in optical contact with or without an adhesive.

The above and other features of the above-discussed aspects will become more readily apparent from the following specific description and drawings accompanying it.

### BRIEF DESCRIPTION OF THE DRAWINGS

FIG. 1 illustrates a highly diagrammatic exemplary schematic of a CPA laser system incorporating the reflective CVBG-based compressor.

FIG. 2 illustrates an exemplary spectral beam combining laser system incorporating a reflective multi VBG-based combiner.

FIGS. 3A-3C illustrate the heat-induced TL phenomenon in a VBG/CVBG which is incorporated in a high-power laser system.

FIG. 4 illustrates the inventive concept of an optical compensator minimizing the beat-induced distortion of the beam which is reflected from VBG/CVBG of the high-power laser system.

FIG. 5 illustrates an exemplary optical schematic of the inventive compensator.

FIG. 6 is a diagrammatic schematic of a laser head of, for example, CPA high power system of FIG. 1 housing the inventive compensating system.

### SPECIFIC DESCRIPTION

FIG. 4 illustrates the basic concept of the disclosed invention including a RVBG, which is shown in the illustrated example as an RCVBG 10 and compensator 32. The RCVBG/RVBG 10 is impinged by incident collimated SM beam 16 after the latter propagates through compensator 32. The incident collimated beam 16 includes a plurality of spectral components at respective different wavelengths [symbol] ₁ . . . [symbol] n. While the laser source of beam 16 may be a continuous wave (CW) laser, the following description is based on experiments with an ultrashort pulsed laser. Accordingly, incident collimated SM beam 16 includes a train of sub-ns pulses each having an average power varying, for example, between 1W and 1 kW. The average power range is exemplary and may be changed. The RCVBG 10 is made of photothermo-refractive glasses (PTR) having, for example, a refractive index n=1.45.

When collimated incident beam 16 propagates through compensator 32, a refractive index of the latter changes over the temperature (dn/dT). In other words, beam 16 induces a TL 20 which has its power dependent on the average power of incident beam 16. Within the context of the shown schematic, compensator 32 is an optical component made of materials, such as CaF of SCHOTT N-PK51 with refractive index n=1.51 or others, which are selected to have a dn/dT value opposite to that one of RCVBG 10. In other words, TL 20 induced by propagating incident beam 16 is negative in the illustrated schematic. In a propagating direction, when light is guided through a negative lens, like TL 20, light's frequency components each begin to diverge at the output of negative lens 20 within compensator 32. The beam 16 continues to diverge as it is guided through faces 42 and 22 of respective compensator 32 and RCVBG 10. As it propagates through the latter, it induces positive TL 14.

The positive TL lens 14 affects incident beam 16 in the manner opposite to that of negative TL 20 which diverges incident collimated beam 16. Accordingly, TL 14 causes diverging beam 16 to converge and become substantially collimated again at the output of TL 14, as denoted by numeral reference 16′. Thus TL 14 compensates for the optical aberration of incident beam 16 produced by negative TL 20 in the incidence direction.

Similarly, when collimated beam 16′, is reflected propagating in the reflected direction as beam 30, which has an average power comparable to that of beam 16, beam 30 starts converging in positive TL 14 of RCVBG 10. However, this convergence now is compensated in negative TL 20 of compensator 32 which thus outputs collimated reflected beam 30. As a consequence, the use of TL 20 at least minimizes heat induced degradation of reflected beam 30 which has the M² factor not exceeding the preset threshold. The latter depends on the quality of incident beam 16, which can be a “pure” SM beam with an M^{2≤1.05} and as low as 1.01 or a few-mode beam with the M² factor≤1.4, and the lens power. Thus, the M² threshold of reflected compressed beam 30 preferably varies between 1.01 and 1.4. The refractive indices of VBG 10 and compensator 32 are not limited to above-disclosed materials and can be selected from the standard glass characteristics specified in Schott and Corning catalogs.

The M² factor of reflected beam 30 is further improved by selecting the geometry of compensator 32 which affects the lens power of negative TL 20. The longer the compensator and/or higher the temperature of the entire component, for example 200-300° C., the higher TL power. The lens power is the reciprocal of a lens's focal length, i.e., the stronger the lens, the shorter its focal length. While the variation of the focal length is undesirable, as will be discussed below, the lens power/focal length of TL 20 may match that of TL 14 of RCVBG compressor 10. The lens power and therefore focal distance of negative TL 20 is a function of the compensator's geometry. Accordingly, compensator 32 may be configured to have its length selected so that both TLs 14 and 20, respectively, are substantially the same.

The smaller the distance between RCVBG 10 and compensator 32, the more stable the position of the beam waist within the Rayleigh length of reflected beam 30 which is beneficial not only to the quality of this beam, but also to the quality of the workpiece to be processed. As a rule, when the laser system is deployed in the field, the distance between the workpiece and a focusing lens housed in the laser head is strictly specified. If the waist position of compressed pulses of beam 30 incident on the focusing lens varies uncontrollably, the quality of the workpiece suffers. Optimally, RCVBG 10 and compensator 32 have respective opposing faces 22 and 42 coupled together. One structural possibility includes processing faces 22, 42 respectively so that they are in optical contact with one another. Another possibility includes providing a housing which is shaped and dimensioned to have the opposing faces of respective RVBG 10 and compensator 32 mechanically coupled to one another.

To even further improve the quality of compressed beam 30, the lens power of TL 20 can be adjusted by controllably heating compensator 32. This can be accomplished by any controllable heater that can selectively heat various regions along the compensator's length.

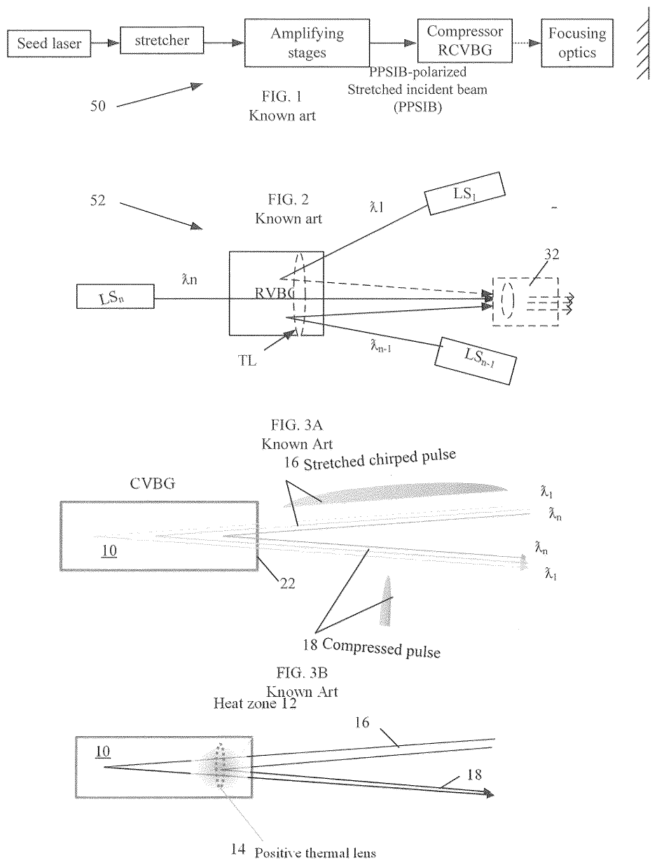

The following table illustrates the advantages of having compensator 32 incorporated in CPA laser system of FIG. 1.

TABLE

| | | |
|---|---|---|
| | | Waist Shift, |
| Power, W | M² | Rayleigh length |

No Compensator

| | | |
|---|---|---|
| 10 | 1.1 | −146% |
| 50 | 1.25 | −70% |
| 100 | 1.5 | 0% |

15 mm Compensator

| | | |
|---|---|---|
| 10 | 1.08 | −80% |
| 50 | 1.15 | −56% |
| 100 | 1.40 | 0% |

25 mm Compensator

| | | |
|---|---|---|
| 10 | 1.1 | −72% |
| 50 | 1.19 | −34% |
| 100 | 1.39 | 0% |

2 × 15 mm Compensator

| | | |
|---|---|---|
| 10 | 1.09 | −67% |
| 50 | 1.12 | −36% |
| 100 | 1.4 | 0% |

25 mm + 15 mm Compensator

| | | |
|---|---|---|
| 10 | 1.1 | 61% |
| 50 | 1.1 | |
| 100 | 1.27 | 0% |

As indicated in the table, the tests have been conducted on system 50 of FIG. 1 provided with a laser source operating within a 10-100 W average power range. First, the system was tested without the disclosed compensator 32 of FIG. 4. As anticipated, the M² factor at low average powers was lower than at high average powers. Taking the beam waist position/Rayleigh length of the reflected beam at 100W as a reference value, the table indicates a gradual shift of the waist of this beam away from RCVBG compressor 10 since the lens power decreases. The waist position at 10W is shifted at 146% relative to the reference value.

The incorporation of compensator 32 of FIG. 4 in system 50 of FIG. 1 lowers the M² factor at 100W from 1.5 to about 1.4. The compensator also minimizes the waist shift at 10W from the reference value almost in half. The increased compensator's length and number of compensators 32 further improve the above-discussed beam characteristics.

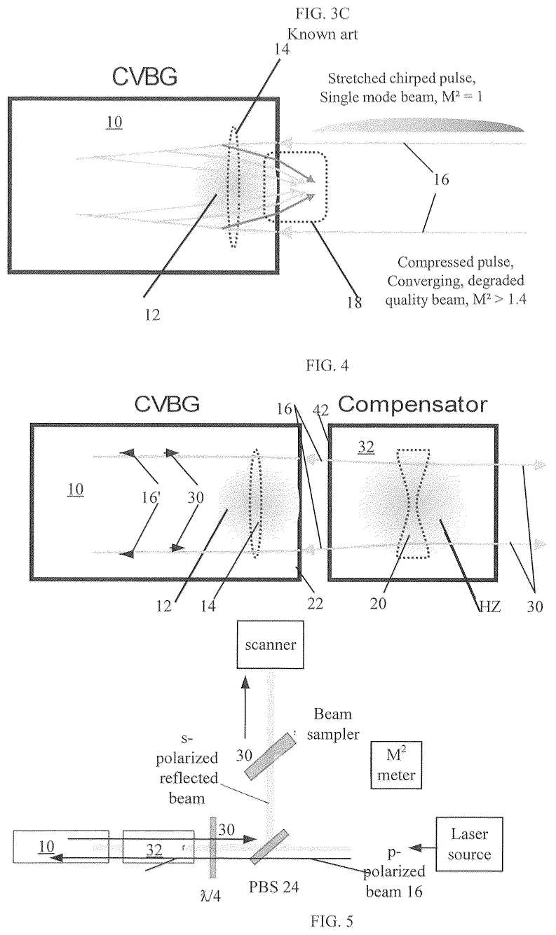

FIG. 5 illustrates an exemplary experimental optical schematic of the disclosed improvement. The laser source, which can be either of systems 50, 52 of respective FIGS. 1 and 2, outputs linearly p-polarized beam 16 propagating through a polarization beam splitter (BPS) 24, [symbol] /4 waveplate, compensator 32 before it is coupled into reflective VBG 10. Upon reflecting, combined output beam 30 is coupled into compensator which is selected from material in which TL 20 of FIG. 4 is generated with the dn/dT value opposite to that of TL 14 in VBG 10 of FIG. 4. Within the specified power range of the laser source, the dimensions of the compensator and power of TL 20 are determined to a. limit the M² of collimated reflected beam 30 to about 1.4 and b. provide the waist shift limited to 60-75% of the reference value corresponding to the waist position of the reflected beam at the optimal power which is arbitrarily selected from the specified power range.

Thereafter, reflected beam 30 is guided through the [symbol] /4 waveplate changing the p-polarization to s-polarization which allows BPS 24 reflect this beam towards the output of the illustrated system. Any suitable device including, for example, the scanner, can receive this beam from the output. Along the light path towards the output, collimated reflected beam 30 can be tapped for measuring its M² factor.

The position of compressor 10 and compensator 32 can be altered. For example, it is possible to place compensator 32 downstream from BPS 24 along the path of reflected beam 30 provided that the distance between these components remains one or two orders of magnitude less than the focal length of positive TL 14. Another example is known system 52 of FIG. 2. As shown by phantom lines, this system may incorporate inventive compensator 32 located downstream from the RVBG and made from a material generating a negative TL which compensates the convergence of incident beams and outputs a combined substantially collimated beam. Thus, the geometry in which collimated incident beam 16 is directly incident on RVBG 10, forms TL 14 with one of positive or negative values, and, upon reflection, is coupled into compensator 32 is also within the scope of this disclosure. Of course, TL 20 of compensator 32 should not only have the value opposite to that of TL 10, but also should be strong enough to compensate for the aberrations induced on the incident beam by TL 14 of RCVG 10.

In summary, the methodology of optimizing the disclosed laser system with compensator 32 of FIGS. 4 and 5, includes determining the focal length/lens power of TL 14 generated in VBG 10 known to one of ordinary skill in the optics. For example, one of the known measurement techniques is based on the beam parameters and position of TL 14. Still another technique allows for the direct measurement of the mode conversion coefficient of the thermal lens. The same techniques are readily applicable to the determination of the opposite TL.

Further, the material of compensator 32 is selected followed up by selecting the geometry and quantity of compensators 32 all affecting the power of TL 20 of FIG. 4 of compensator 32. The determination of the power TL. 20 helps minimize the heat-induced beam degradation by TL 14 of VBG 10 to the desired M² quality of reflected beam 30 which preferably does not exceed 1.4. In some instances, this M² threshold may be slightly higher if the product specification allows it. If fine adjustment of the TL power and thus beam quality is needed, a temperature control of compensator 32 is used.

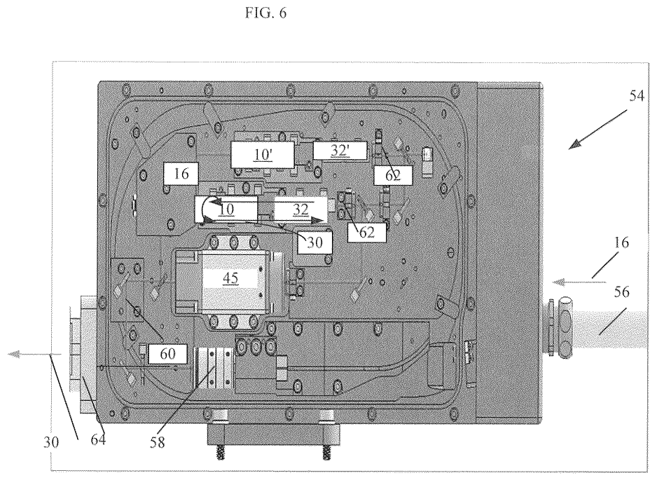

FIG. 6 illustrates an exemplary laser head 54 of, for instance, CPA laser system 50 of FIG. 1. The combination of compressor 10 and compensator 32 is mounted to the laser head. The laser source linearly polarized light, i.e., a train of stretched pulses of beam 16 at a wavelength, varying in a UV-IR wavelength spectral region, is delivered to laser head 54 by a feeding fiber 56. Along light path 60, coupled beam 16 is first amplified in a final amplification stage-booster 58. The booster 58 may have fiber or YAG geometry. The amplified stretched pulses propagate further through an isolator 45, PBS and ¼ waveplate combination 62 and further is coupled into compensator 32 and RCVBG compressor 10 from which it is reflected in the above-disclosed manner as reflected beam 30. In some embodiments, mainly related to fiber amplifiers, the pulses of input beam 16 are stretched multiple times to avoid the low onset of nonlinear effects. The compression of these multi-stretched pulses is preferably realized by multiple compressors. Accordingly, reflected beam 30 is then coupled into a following compensator 32′, compressor 10′ in which it reflects and, after going through an optical expander, exits laser head 54 via an output 64.

Having thus described the aspects of the disclosure, it is to be appreciated that various alterations, modifications, and improvements will readily occur to those skilled in the art. For instance, examples disclosed herein may also be used in other contexts. Such alterations, modifications, and improvements are intended to be part of this disclosure and are intended to be within the scope of the examples discussed herein. Accordingly, the foregoing description and drawings are by way of example only.

1. A high-power laser system comprising:
at least one reflective volume Bragg grating (RVBG) impinged upon by a beam which is absorbed in material of the RCVBG to induce a first thermal lens (TL), the RVBG being configured to reflect the beam so that the reflected beam propagates though the first TL before exiting the RVBG; and
at least one compensator receiving the reflected beam absorbed in a compensator's material, which is different from that of the RVBG, and inducing a second TL, the first and second TLs having respective lens powers opposite to one another so that the second TL at least minimizes thermally induced beam degradation of the reflected beam caused by the first TL.

2. The high-power laser system of claim 1 further comprising:
a CPA laser source outputting the beam of stretched linearly polarized collimated ultrashort pulses along an incidence path,
a laser head located downstream from the laser source and housing the RVBG and compensator,
a beam polarization splitter (BPS) mounted in the laser head and transmitting the polarized collimated stretched pulses along the incidence path while deflecting the reflected beam off the incidence path along a reflected path which extends transversely to the incidence path, and
a polarizer mounted in the laser head between the BPS and the RVBG, wherein the RVBG is chirped (RCVBG).

3. The high-power laser system of claim 2, wherein the compensator is located along the incidence path between the polarizer and RVBG so that the collimated stretched pulses each propagate through the compensator inducing the second TL, the second lens power being negative, wherein the second TL causes the collimated stretched pulses each to diverge before the diverged stretched pulse is coupled into the RCVBG where the first TL has the first lens power positive to at least partially minimize or fully compensate the divergence of the coupled pulse.

4. The high-power system of claim 3, wherein the coupled stretched pulse is compressed and reflected propagating in the RCVBG back to and through the first positive lens which causes the compressed pulse to converge before it is coupled into the compensator in which the second negative TL compensates for the convergence of the compressed reflected pulse outputting thus a substantially collimated compressed pulse towards and output of the laser head.

5. The high-power laser system of claim 1, wherein the RVBG and compensator are spaced at a distance from one another which is one or two orders of magnitude less than a focal lens of the first TL.

6. The high-power laser system of claim 2 further comprising at least one additional compensator and additional RCVBG along the incidence path so as to receive the reflected compressed pulses from the one compensator.

7. The high-power laser system of claim 2, wherein the laser source operates within a power range including a plurality of power values which are different from one another, the heat induced thermal degradation of the reflected beam being represented by the M² beam factor and a waist position of the reflected beam with the latter being selected at a reference power value from within the range of power values.

8. The high-power laser system of claim 7, wherein the second TL is configured to limit a drift of the desired value of M² beam factor of the reflected beam within a 1.01 and 1.4 range and a shift of the beam waist of the reflected beam above about 75% of the beam waist's location at the reference power.

9. The high-power laser system of claim 1, wherein the material of the VBG is photothermo-refractive (PTR) glass having a refractive index different from that of the compensator which is selected from glasses other than PTR.

10. The high-power laser system of claim 1 further comprising a thermoelectric cooler controllably altering a temperature of the compensator.

11. The high-power laser system of claim 1, wherein the laser source includes a plurality of laser sources spaced from one another and emitting respective output SM or low mode beams at respective different wavelengths at angles of incidence which are different from one another, the RVBG being configured to combine the incident beams into a combined reflected beam, the combined beam propagating through the first TL and being coupled into the compensator so that the second TL minimizes the thermally induced beam degradation.

12. A method for compensating thermally induced beam degradation in reflective volume Bragg grating (RVBG) receiving at least one SM or low-mode incidence stretched beam from at least one laser source, comprising:
determining a power of a first thermal lens (TL) induced upon absorbing the incidence beam, and configured to compress the incidence beam and reflect the compressed beam; and
coupling the reflected beam into a compensator made from a material different from that of the RVBG, the material of the compensator absorbing the reflected beam thereby inducing a second TL which has a lens power value opposite to that of the RVBG, thereby at least partially compensating the degradation of the reflected beam which is thermally induced by the first TL.

13. The method of claim 12 further comprising determining a lens power of the second TL of the compensator and adjusting the lens power to match that of the first TL.

14. The method of claim 13, wherein the power adjustment of the of the second TL includes a step consisting of the group selected from selecting a length of the compensator, controllably heating the compensator or a combination length adjustment and heating.

15. The method of claim 12 further positioning the RVBG and compensator at a distance at least one or two orders of magnitude smaller than a focal length of the first TL.

16. The method of claim 12 further comprising operating the laser source in a range of powers, so that the heat induced thermal degradation of the reflected beam in the second TL of the compensator is represented by an M² beam factor and a waist position of the reflected beam, wherein the M² beam factor is at most equal to or lower than 1.4 at any power of the power range, and a shift of the beam waist is at most equal to 75% of a beam waist location which is determined at a reference power selected from the power range.

17. The method of claim 12, wherein the VBG combines a plurality of SM beams at respective different wavelengths output by a plurality of the laser sources at respective angles which are different from one another.

18. The method of claim 12, wherein the RVBG is configured with a chirp and incorporated in a CPA laser system to compresses the coupled SM beam.
